(19) United States
(12) Patent Application Publication
(10) Pub. No.: US 2026/0188047 A1
(43) Pub. Date: Jul. 2, 2026

(54) METHOD FOR GENERATING DRIVEN DIGITAL HUMAN EXPRESSION

(71) Applicant: Nanjing Silicon Intelligence Technology Group Co., Ltd, Nanjing (CN)

(72) Inventors: Hua Peng SIMA, Nanjing (CN); Jiawei SUN, Nanjing (CN)

(73) Assignee: Nanjing Silicon Intelligence Technology Group Co., Ltd, Nanjing (CN)

(21) Appl. No.: 19/433,676

(22) Filed: Dec. 26, 2025

(30) Foreign Application Priority Data
Dec. 27, 2024 (CN) 202411941998.5

(51) Int. Cl. G06V 40/16; G06T 17/10; G06V 10/70

(52) U.S. Cl. CPC G06V 40/168; G06T 17/10; G06V 10/70

(57) ABSTRACT

The present application provides a method for generating driven digital human expression, relating to the technical field of digital human generation. The generation method includes acquiring a driving video and a driven video, where the driving video is an expression provider of the driven video; inputting the driving video into a target 3D face reconstruction model to obtain target facial coefficient features; inputting the target facial coefficient features and the driven video into a target expression generation model to obtain a driven image with a target expression; and performing video encoding based on the driven image to obtain a target video, where the target video is a video combining face information of the driven video with the target expression of the driving video. Through the above-mentioned generation method, the present application solves the problem that the driven digital human expressions generated based on existing technologies are too rigid.

### CROSS-REFERENCE TO RELATED APPLICATIONS

The present application claims the benefit of and priority to Chinese patent application No. 202411941998.5 filed on December 27, 2024, the content of the aforementioned applications is incorporated herein by reference in its entirety.

### TECHNICAL FIELD

The present invention relates to the technical field of digital human generation, and particularly relates to a method for generating driven digital human expression.

### BACKGROUND

Research on digital human expressions is an important part of the field of natural human-computer interaction, which aims to accurately apply facial expressions to digital humans, enabling the digital humans to present realistic emotional expressions, improve user experience, promote emotional resonance, and bring higher sense of immersion and authenticity to human-computer interaction. The driving of digital human expressions by facial coefficients is realized by acquiring and encoding facial expression coefficients in a driving video to drive the digital humans to generate expressions.

At present, research on driving digital human expressions by facial coefficients mainly focuses on the optimization of expression effects. Most technologies for driving digital humans by facial coefficients can achieve good migration effects in simple expressions such as smiling and happiness or in face reconstruction, but cannot realize the migration of subtle, exaggerated, asymmetric, or continuous expression changes. In many application scenarios, unrealistic digital human expressions will lead to insufficient emotional communication, reduce interaction experience, result in poor communication effects, and further affect users' willingness to participate and overall satisfaction. At present, there is no method in the related technologies that can realize the generation of digital human expressions driven by facial coefficients, and this is a bottleneck that needs to be solved for driving digital human expressions by facial coefficients.

### SUMMARY

The present application provides a method for generating driven digital human expression, so as to solve the problem that the driven digital human expressions generated based on existing technologies are too rigid.

The generation method includes:

acquiring a driving video and a driven video, where the driving video is an expression provider for the driven video;

inputting the driving video into a target 3D face reconstruction model to obtain target facial coefficient features, where the target 3D face reconstruction model performs feature extraction on the driving video based on a skip connection approach;

inputting the target facial coefficient features and the driven video into a target expression generation model, where the target expression generation model is configured to perform global feature analysis and local feature analysis according to the target facial coefficient features and the driven video, so as to obtain a driven image with a target expression; and

performing video encoding based on the driven image to obtain a target video, where the target video is a video combining face information of the driven video with the target expression of the driving video.

Preferably, the training process of the target 3D face reconstruction model includes:

acquiring an expression video, and performing first preprocessing on the expression video to obtain a target expression video; and

performing model training and convergence according to the target expression video and a 3D face reconstruction model to obtain the target 3D face reconstruction model.

Preferably, the step of performing model training according to the target expression video and the 3D face reconstruction model includes:

selecting several frames of training expression images from the target expression video;

performing first processing according to the training expression images to obtain facial coefficient features; and

repeating the training of the 3D face reconstruction model, and performing convergence on the facial coefficient features by using a first loss-function until the 3D face reconstruction model meets a first requirement, so as to obtain the target 3D face reconstruction model.

Preferably, the procedure of performing first processing according to the training expression images includes:

performing reconstruction processing and masking processing on the training expression images respectively to obtain first reconstruction features and first masked images;

performing skip feature fusion processing according to the first reconstruction features and the first masked images to obtain first fusion features; and

performing encoding processing on the first fusion features to obtain the facial coefficient features.

Preferably, the procedure of performing reconstruction processing on the training expression images includes:

performing encoding processing on the training expression images to obtain first encoding features; and

performing 3D face mesh reconstruction on the first encoding features to obtain the first reconstruction features.

Preferably, the procedure of performing convergence on the facial coefficient features by using the first loss-function includes:

calculating a first deviation between the facial coefficient features and the training expression images by using an L1 loss-function;

calculating a second deviation between the facial coefficient features and the training expression images by using a cycle loss-function; and

stopping the training of the 3D face reconstruction model when both the first deviation and the second deviation meet the first requirement, so as to obtain the target 3D face reconstruction model.

Preferably, the target 3D face reconstruction model includes a first convolution encoding unit, an image masking unit, a 3D face mesh reconstruction unit, a feature fusion unit, and a second convolution encoding unit;

where the feature fusion unit includes an encoding layer and a decoding layer, where the encoding layer includes a first encoding layer, a second encoding layer, and a third encoding layer connected in sequence, the decoding layer includes a first decoding layer, a second decoding layer, and a third decoding layer connected in sequence, where the third encoding layer is connected with the first decoding layer; and a skip connection is presented between the encoding layer and the decoding layer;

where the first encoding layer, the second encoding layer, and the third encoding layer are all configured to perform down-sampling on features input from a previous layer; and the first decoding layer, the second decoding layer, and the third decoding layer are all configured to perform up-sampling on features input from the previous layer.

Preferably, the training process of the target expression generation model includes:

acquiring a training driving video, and performing second preprocessing on the training driving video to obtain a target training driving video; and

performing model training and convergence according to the target training driving video, the facial coefficient features, and an expression generation model, so as to obtain the target expression generation model.

Preferably, the step of performing model training according to the target training driving video, the facial coefficient features, and the expression generation model includes:

performing convolution encoding on the target training driving video and the facial coefficient features respectively to obtain second encoding features and third encoding features;

performing feature fusion on the second encoding features and the third encoding features by using a second processing to obtain second fusion features, where the second processing includes adaptive normalization processing with an attention mechanism;

performing residual calculation on the second fusion features to obtain first residual features;

performing deconvolution processing on the first residual features to obtain first deconvolution features;

performing third processing on the first deconvolution features to obtain a training driven image, where the third processing includes extracting deep features in the first deconvolution features by using spatial normalization processing, and adjusting normalization parameters of the spatial normalization processing uniformly and adaptively;

performing video encoding according to the training driven image to obtain a training target video; and

performing convergence on the training target video by using an L1 loss-function until the expression generation model meets a second requirement, so as to obtain the target expression generation model.

Preferably, the second processing includes:

dividing the second encoding features and the third encoding features into a plurality of subsequences, performing feature encoding processing on each of the subsequences, calculating attention weights corresponding to different subsequences through a spatial attention module, and fusing a plurality of feature encoding processing results based on attention weight calculation results to obtain local feature encodings, where the spatial attention module is preset in the expression generation model;

dividing the local feature encodings into a plurality of subsequences, performing feature encoding processing on each of the subsequences, calculating attention weights corresponding to different subsequences through the spatial attention module, and fusing a plurality of feature encoding processing results based on attention weight calculation results to obtain local feature encodings;

performing iterative update, and independently outputting the local feature encodings obtained in each round to obtain a plurality of local feature encodings; and

calculating attention weights of the plurality of local feature encodings according to a channel attention module, and performing feature processing based on attention weight calculation results to obtain global feature encodings; and fusing the plurality of local feature encodings with the global feature encodings to obtain the second fusion features; where the channel attention module is preset in the expression generation model.

Preferably, the procedure of performing convergence on the training target video by using the L1 loss-function includes:

calculating a third deviation between the training target video and the target expression video by using the L1 loss-function; and

stopping the training of the expression generation model when the third deviation meets the second requirement, so as to obtain the target expression generation model.

It can be known from the above content that the present application provides a method for generating driven digital human expression. The generation method includes acquiring a driving video and a driven video, where the driving video is an expression provider of the driven video; inputting the driving video into a target 3D face reconstruction model to obtain target facial coefficient features; inputting the target facial coefficient features and the driven video into a target expression generation model to obtain a driven image with a target expression; performing video encoding based on the driven image to obtain a target video, where the target video is a video combining face information of the driven video with the target expression of the driving video. The present application solves the problem that the driven digital human expressions generated based on existing technologies are too rigid through the above-mentioned generation method.

### BRIEF DESCRIPTION OF THE DRAWINGS

To more clearly illustrate the technical solutions of the present application, the drawings required for the embodiments will be briefly introduced below. Obviously, for those of ordinary skill in the art, other drawings can also be obtained based on these drawings without making creative efforts.

FIG. 1 is a flow chart of a method for generating driven digital human expression of the present application;

FIG. 2 is a training flow chart of a 3D face reconstruction model in the method for generating driven digital human expression of the present application;

FIG. 3 is a specific training flow chart of the 3D face reconstruction model in the method for generating driven digital human expression of the present application;

FIG. 4 is a flow chart of obtaining facial coefficient features in the method for generating driven digital human expression of the present application;

FIG. 5 is a flow chart of a convergence mode of the 3D face reconstruction model in the method for generating driven digital human expression of the present application;

FIG. 6 is a schematic diagram of a target 3D face reconstruction model in the method for generating driven digital human expression of the present application;

FIG. 7 is a schematic diagram of a feature fusion unit in the target 3D face reconstruction model;

FIG. 8 is a training flow chart of an expression generation model in the method for generating driven digital human expression of the present application;

FIG. 9 is a specific training flow chart of the expression generation model in the method for generating driven digital human expression of the present application;

FIG. 10 is a flow chart of a convergence mode of the expression generation model in the method for generating driven digital human expression of the present application;

FIG. 11 is a comparison diagram of human faces before and after masking processing in the method for generating driven digital human expression of the present application;

FIG. 12 is a schematic diagram of the expression generation model in the method for generating driven digital human expression of the present application;

FIG. 13 is a flow chart of a second processing in the method for generating driven digital human expression of the present application.

### DETAILED DESCRIPTION

The technical solutions in the embodiments of the present invention will be clearly and completely described below in conjunction with the drawings in the embodiments of the present invention. Obviously, the described embodiments are only a part of the embodiments of the present invention, rather than all the embodiments. Based on the embodiments in the present invention, all other embodiments obtained by those of ordinary skill in the art without making creative efforts shall fall within the protection scope of the present invention.

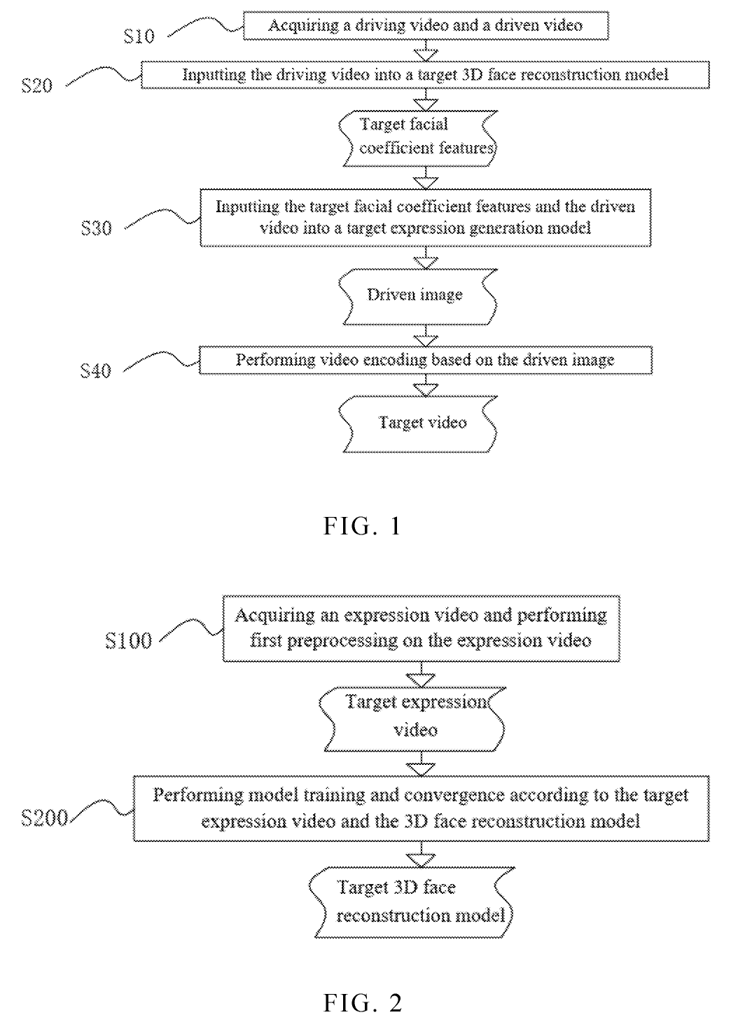

FIG. 1 is a flow chart of a method for generating driven digital human expression of the present application.

As can be seen from FIG. 1, the present embodiment provides a method for generating driven digital human expression, and the generation method includes:

S10, acquiring a driving video and a driven video. Specifically, in the present embodiment, before generating a digital human, it is necessary to first acquire a driving object and a driven object of the digital human, where the driving video is an expression provider of the driven video.

The driving video is a recorded video of an actual user, and the driven video can be a video of a virtual streamer image or a virtual girlfriend image.

It should be noted that the driven video can be acquired only after obtaining permission. It can be understood that some virtual character image videos require usage permission, so they can be used only after obtaining permission.

The generation method further includes:

S20, inputting the driving video into a target 3D face reconstruction model. Specifically, in the present embodiment, before generating an expression video, it is necessary to first perform video reconstruction on the driving video, so as to improve the accuracy and detail richness of the facial expression images in the driving video.

In the present embodiment, the driving video is input into the target 3D face reconstruction model for face reconstruction processing, so as to obtain the feature after face reconstruction, that is, the target facial coefficient feature.

The generation method further includes:

S30, inputting the target facial coefficient features and the driven video into a target expression generation model. Specifically, in the present embodiment, in the conventional technology for generating driven digital human expression, expression migration is generally performed directly between an expression provider and an expression receiver, which leads to problems such as incoherence and inconsistency of the generated expressions; in the above step S20, face reconstruction has been performed on the expression provider, that is, the driving video. However, if the generated expression is to be more natural, it is necessary to perform certain processing on the expression receiver as well, and perform corresponding facial processing on both the expression provider and the expression receiver at the same time, so that the authenticity of the generated expression can be further improved.

In the present embodiment, since it is necessary to migrate the expression from one video object to another video object, the video objects cannot be processed separately; for this reason, in the present embodiment, the target facial coefficient features obtained in step S20 and the driven video used for receiving the expression are input into the target expression generation model for expression migration, so as to obtain the image after expression migration, that is, the driven image with the target expression.

The generation method further includes:

S40, performing video encoding based on the driven image. Specifically, in the present embodiment, in step S30, the driven image with the migrated expression has been obtained, but a single image cannot form a complete video. Therefore, it is necessary to perform video encoding on the driven image to convert the image into a video, so as to obtain the target video.

The target video is a video combining the face information of the driven video with the target expression of the driving video.

FIG. 2 is a training flow chart of a 3D face reconstruction model in the method for generating driven digital human expression of the present application.

As can be seen from FIG. 2, further, in some embodiments, the training process of the target 3D face reconstruction model includes:

S100, acquiring an expression video and performing first preprocessing on the expression video. Specifically, in the present embodiment, since the target 3D face reconstruction model is used for expression reconstruction and feature extraction of the expression provider, the training of the target 3D face reconstruction model also needs to acquire the corresponding expression video. There are various types of videos, but the target 3D face reconstruction model requires the expression video to have complete and clear expressions.

The expression video used for training is generally acquired from an open-source video database, and the quality of such a video cannot perfectly meet the requirements of the training data required by the target 3D face reconstruction model. Therefore, it is necessary to perform the first preprocessing on the expression video to obtain a video that meets the training requirements of the target 3D face reconstruction model.

The first preprocessing may include data enhancement operations such as face detection, key point detection, random brightness processing, contrast processing, color jitter processing, Gaussian noise processing, and blurring processing according to different situations. It should be noted that during the training process of the target 3D face reconstruction model, it is necessary to preprocess the expression-providing video object, but in the actual application of the target 3D face reconstruction model, the expression-providing video object does not need to be preprocessed. The preprocessing of data in the training stage is for better model training, and each step in the first preprocessing is not a necessary condition for model training.

After performing the first preprocessing on the expression video, a preprocessed target expression video is obtained.

S200, performing model training and convergence according to the target expression video and the 3D face reconstruction model. Specifically, in the present embodiment, during the process of performing model training on the 3D face reconstruction model by using the expression video, it is necessary to perform loss convergence on the 3D face reconstruction model, so as to obtain the target 3D face reconstruction model that meets the target requirements.

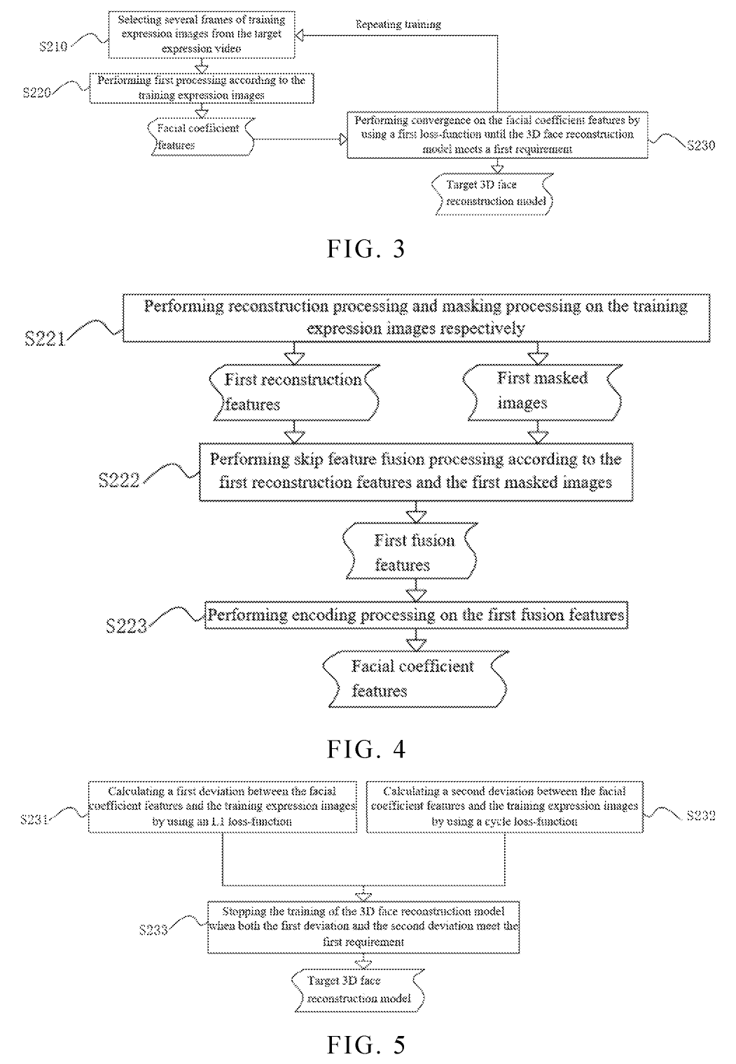

FIG. 3 is a specific training flow chart of the 3D face reconstruction model in the method for generating driven digital human expression of the present application.

As can be seen from FIG. 3, further, in some embodiments, the step of performing model training according to the target expression video and the 3D face reconstruction model includes:

S210, selecting several frames of training expression images from the target expression video. Specifically, in the present embodiment, during the training process of the 3D face reconstruction model, it is necessary to select a certain number of image frames from the target expression video and perform training according to the image frames.

The step of performing model training according to the target expression video and the 3D face reconstruction model further includes:

S220, performing first processing according to the training expression images. Specifically, in the present embodiment, the target expression video is input into the 3D face reconstruction model, and the 3D face reconstruction model is used to perform first processing on several image frames of the target expression video, so as to obtain the facial coefficient features corresponding to the face in the target expression video.

The step of performing model training according to the target expression video and the 3D face reconstruction model further includes:

S230, repeating the training of the 3D face reconstruction model, and performing convergence on the facial coefficient features by using a first loss-function until the 3D face reconstruction model meets a first requirement. Specifically, in the present embodiment, the facial coefficient features obtained in the above step S220 are the output of the model. However, if the model is to be trained, it is necessary to continuously perform loss convergence on the facial coefficient features, so as to continuously improve the 3D face reconstruction model.

During the training process of the 3D face reconstruction model, the first loss-function is used to calculate the loss of the facial coefficient features output each time, so as to realize the convergence of the 3D face reconstruction model and finally obtain the target 3D face reconstruction model.

FIG. 4 is a flow chart of obtaining facial coefficient features in the method for generating driven digital human expression of the present application.

As can be seen from FIG. 4, further, in some embodiments, the procedure of performing first processing according to the training expression images includes:

S221, performing reconstruction processing and masking processing on the training expression images respectively. Specifically, in the present embodiment, the first step of the first processing includes performing reconstruction processing and masking processing on the training expression images respectively. It can be understood that the training expression images are divided into two sequences, reconstruction processing is performed on one sequence, and masking processing is performed on the other sequence; where after the reconstruction processing is performed on the training expression images, first reconstruction features are obtained; and after the masking processing on the training expression images, first masked images are obtained.

The reconstruction processing includes performing encoding processing on the training expression images to obtain first encoding features; and performing 3D face mesh reconstruction on the first encoding features to obtain first reconstruction features.

The images after the masking processing and the images before the masking processing can be referred to in FIG. 11. As can be seen from FIG. 11, the masking processing is to mask the important areas of the face in the face image. The reason is that the acquisition of face features needs to cover the features of the entire face, so it is necessary to black out all the important feature areas of the entire face, so as to provide an effective data foundation for subsequent feature fusion.

The procedure of performing first processing according to the training expression images further includes:

S222, performing skip feature fusion processing according to the first reconstruction features and the first masked images. Specifically, in the present embodiment, feature fusion processing is performed on the first reconstruction features and the first masked images obtained in step S221, where the feature fusion processing is skip fusion processing, and its principle is based on the neural network structure with shortcut connections.

Skip feature fusion processing is performed on the first reconstruction features and the first masked images, so as to obtain first fusion features.

The procedure of performing first processing according to the training expression images further includes:

S223, performing encoding processing on the first fusion features. Specifically, in the present embodiment, after step S222 is completed, encoding processing is performed on the first fusion features obtained in step S222 to obtain the corresponding features, that is, the facial coefficient features.

It should be noted that although the above steps S221 to S223 are processes in model training, they are the same as steps S221 to S223 in the actual application of the model.

FIG. 5 is a flow chart of a convergence mode of the 3D face reconstruction model in the method for generating driven digital human expression of the present application.

As can be seen from FIG. 5, further, in some embodiments, the procedure of performing convergence on the facial coefficient features by using the first loss-function includes:

S231, calculating a first deviation between the facial coefficient features and the training expression images by using an L1 loss-function; and

S232, calculating a second deviation between the facial coefficient features and the training expression images by using a cycle loss-function;

specifically, in the present embodiment, the L1 loss-function and the cycle loss-function are used simultaneously to calculate the deviations between the facial coefficient features and the training expression images, so as to obtain the first deviation and the second deviation.

The procedure of performing convergence on the facial coefficient features by using the first loss-function further includes:

S233, stopping the training of the 3D face reconstruction model when both the first deviation and the second deviation meet the first requirement. Specifically, in the present embodiment, when both the first deviation and the second deviation meet the first requirement, it indicates that the training of the 3D face reconstruction model has been completed, so the training can be stopped, and the target 3D face reconstruction model can be obtained.

The L1 loss-function is used to calculate the L1 reconstruction deviation between the facial coefficient features and the training expression images. In order to make the predicted facial coefficients more accurate and stable, a cycle loss-function is additionally used, that is, the cycle loss between the facial coefficient features and the facial coefficients of the training expression images.

FIG. 8 is a training flow chart of an expression generation model in the method for generating driven digital human expression of the present application.

As can be seen from FIG. 8, further, in some embodiments, the training process of the target expression generation model includes:

S300, acquiring a training driving video and performing second preprocessing on the training driving video. Specifically, in the present embodiment, since the target expression generation model is used for extracting expression features from both the expression receiver and the expression provider, the training of the target expression generation model also needs to acquire the corresponding training driving video. Like the expression video, the training driving video comes in various forms, and the target expression generation model also needs to meet certain requirements.

The training driving video used for training can be acquired from an open-source video database or recorded by model training personnel, and the quality of these videos also varies. Therefore, it is necessary to perform second preprocessing on the training driving video to obtain a video that meets the training requirements of the target expression generation model.

The second preprocessing is quite different from the first preprocessing. The second preprocessing may include video beautification, face detection, and cropping according to different situations. It should be noted that during the training process of the target expression generation model, it is necessary to preprocess the expression receiving video object, but in the actual application of the target expression generation model, the expression receiver does not need to be preprocessed. The preprocessing of data in the training stage is for better model training, and each step in the second preprocessing is not a necessary condition for model training.

After performing the second preprocessing on the training driving video, a preprocessed target training driving video is obtained.

The training process of the target expression generation model further includes:

S400, performing model training and convergence according to the target training driving video, the facial coefficient features, and the expression generation model. Specifically, in the present embodiment, during the process of model training on the expression generation model by using the target training driving video and the facial coefficient features, it is also necessary to perform loss convergence on the expression generation model, so as to obtain a loss target expression generation model that meets the target requirements.

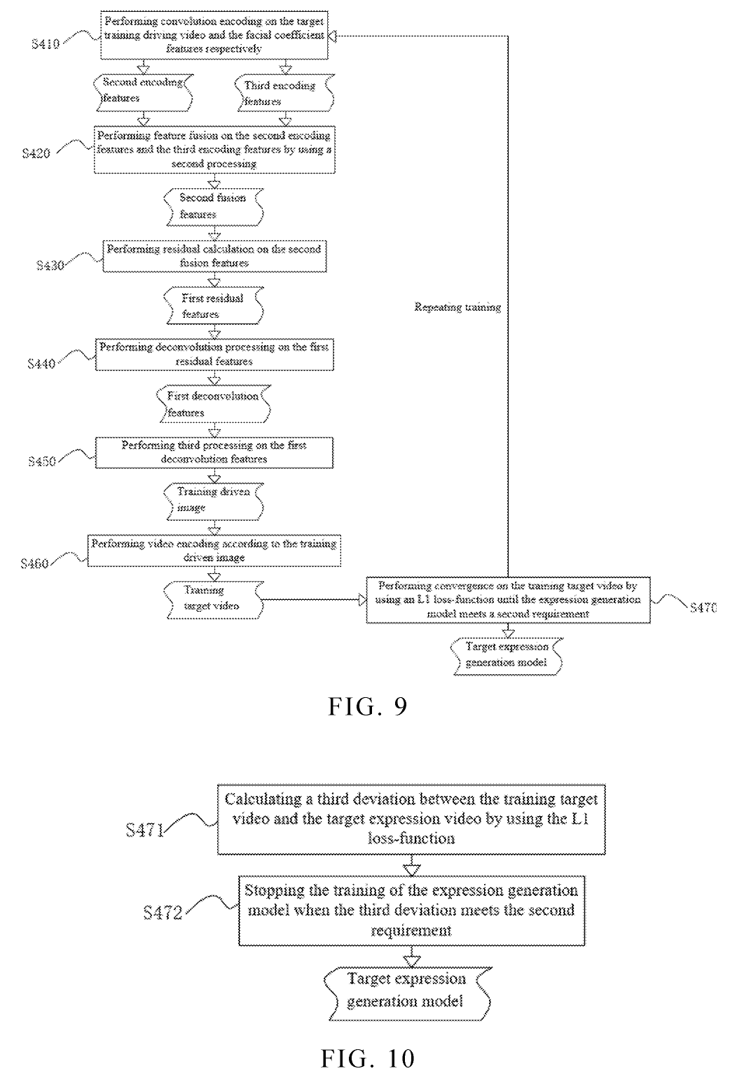

FIG. 9 is a specific training flow chart of the expression generation model in the method for generating driven digital human expression of the present application.

As can be seen from FIG. 9, further, in some embodiments, the procedure of performing model training and convergence according to the target training driving video, the facial coefficient features, and the expression generation model includes:

S410, performing convolution encoding on the target training driving video and the facial coefficient features respectively to obtain second encoding features and third encoding features. Specifically, in the present embodiment, convolution encoding is performed on the target training driving video and the facial coefficient features respectively to obtain the second encoding features and the third encoding features, where the second encoding features correspond to the target training driving video, and the third encoding features correspond to the facial coefficient features.

The procedure of performing model training and convergence according to the target training driving video, the facial coefficient features, and the expression generation model further includes:

S420, performing feature fusion on the second encoding features and the third encoding features by using a second processing to obtain second fusion features, where the second processing includes adaptive normalization processing with an attention mechanism;

S430, performing residual calculation on the second fusion features to obtain first residual features;

S440, performing deconvolution processing on the first residual features to obtain first deconvolution features; and

S450, performing third processing on the first deconvolution features to obtain a training driven image, where the third processing includes extracting deep features in the first deconvolution features by using spatial normalization processing, and adjusting normalization parameters of the spatial normalization processing uniformly and adaptively;

specifically, in the present embodiment, through steps S420 to S450, an improved neural network is used to process the encoding features of the expression provider and the encoding features of the expression receiver, so as to fuse them together, enhance the correlation between the face and the expression, and thus improve the authenticity of the subsequently generated expression video.

The procedure of performing model training and convergence according to the target training driving video, the facial coefficient features, and the expression generation model further includes:

S460, performing video encoding according to the training driven image to obtain a training target video; and

S470, performing convergence on the training target video by using an L1 loss-function until the expression generation model meets a second requirement, so as to obtain the target expression generation model.

Specifically, in the present embodiment, after the processing in steps S420 to S450 is completed, the features are converted into a video, and continuous loss convergence is performed on the generated video, so as to finally obtain the target expression generation model.

FIG. 10 is a flow chart of a convergence mode of the expression generation model in the method for generating driven digital human expression of the present application.

As can be seen from FIG. 10, further, in some embodiments, the procedure of performing convergence on the training target video by using the L1 loss-function includes:

S471, calculating a third deviation between the training target video and the target expression video by using the L1 loss-function; and

S472, stopping the training of the expression generation model when the third deviation meets the second requirement, so as to obtain the target expression generation model.

Specifically, in the present embodiment, similar to the convergence mode of the 3D face reconstruction model, the loss convergence of the expression generation model uses the L1 loss-function to calculate the third deviation between the training target video and the target expression video, and determines whether the training of the expression generation model is completed according to the deviation.

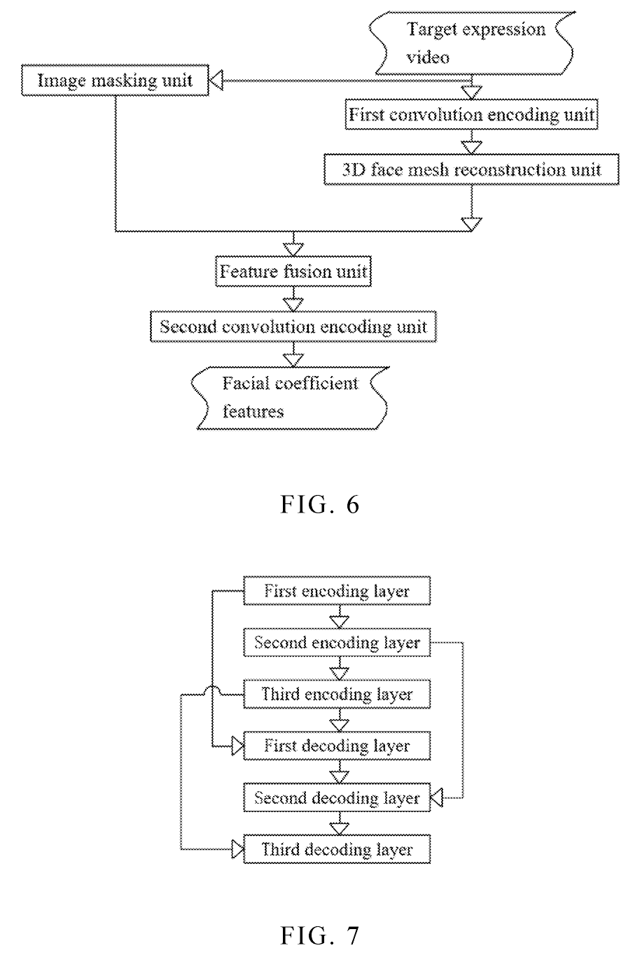

FIG. 6 is a schematic diagram of a target 3D face reconstruction model in the method for generating driven digital human expression of the present application;

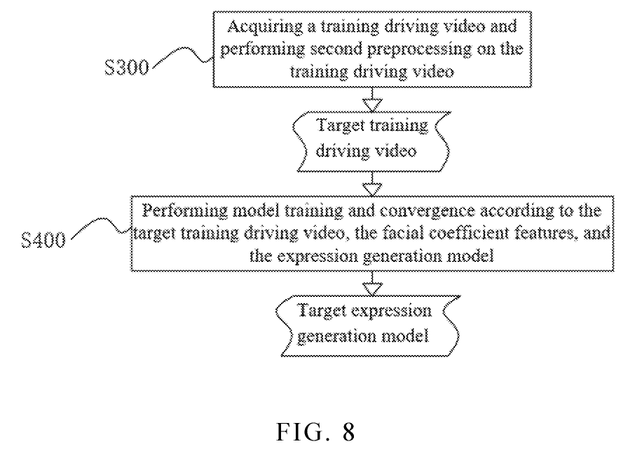

FIG. 7 is a schematic diagram of a feature fusion unit in the target 3D face reconstruction model.

As can be seen from FIG. 6 and FIG. 7, further, in some embodiments, the target 3D face reconstruction model includes a first convolution encoding unit, an image masking unit, a 3D face mesh reconstruction unit, a feature fusion unit, and a second convolution encoding unit;

the feature fusion unit includes an encoding layer and a decoding layer, where the encoding layer includes a first encoding layer, a second encoding layer, and a third encoding layer connected in sequence, the decoding layer includes a first decoding layer, a second decoding layer, and a third decoding layer connected in sequence, and the third encoding layer is connected with the first decoding layer; and a skip connection is presented between the encoding layer and the decoding layer; and

the first encoding layer, the second encoding layer, and the third encoding layer are all configured to perform down-sampling on features input from the previous layer; and the first decoding layer, the second decoding layer, and the third decoding layer are all configured to perform up-sampling on features input from the previous layer.

Specifically, in the present embodiment, the target 3D face reconstruction model takes the target facial coefficient features and the driven video as data input, acquires face coefficients through the first convolution encoding unit, and performs 3D face mesh reconstruction through the 3D face mesh reconstruction unit; and extracts target facial coefficient features through the feature fusion unit and the second convolution encoding unit.

The feature fusion unit includes an improved neural network structure, including three encoding layers for down-sampling and three decoding layers for up-sampling, and each corresponding layer is spliced using shortcut (skip connection); the feature fusion unit takes the output of the image masking unit and the output of the 3D face mesh reconstruction unit as input, and can better capture the edge information of the human face, face texture, expression, and other global information through residuals and skip connections. Specifically, the above three encoding layers gradually reduce the spatial dimension of the image while increasing the number of feature channels; correspondingly, the three decoding layers gradually restore the spatial dimension of the image while reducing the number of feature channels; the three encoding layers and the three decoding layers have a corresponding relationship, and the output of each encoding layer is not only transmitted to the next encoding layer but also directly transmitted to the corresponding decoding layer (the data transmission relationship here can be understood as the above skip connection), thereby ensuring information fusion and alleviating the problem of gradient disappearance.

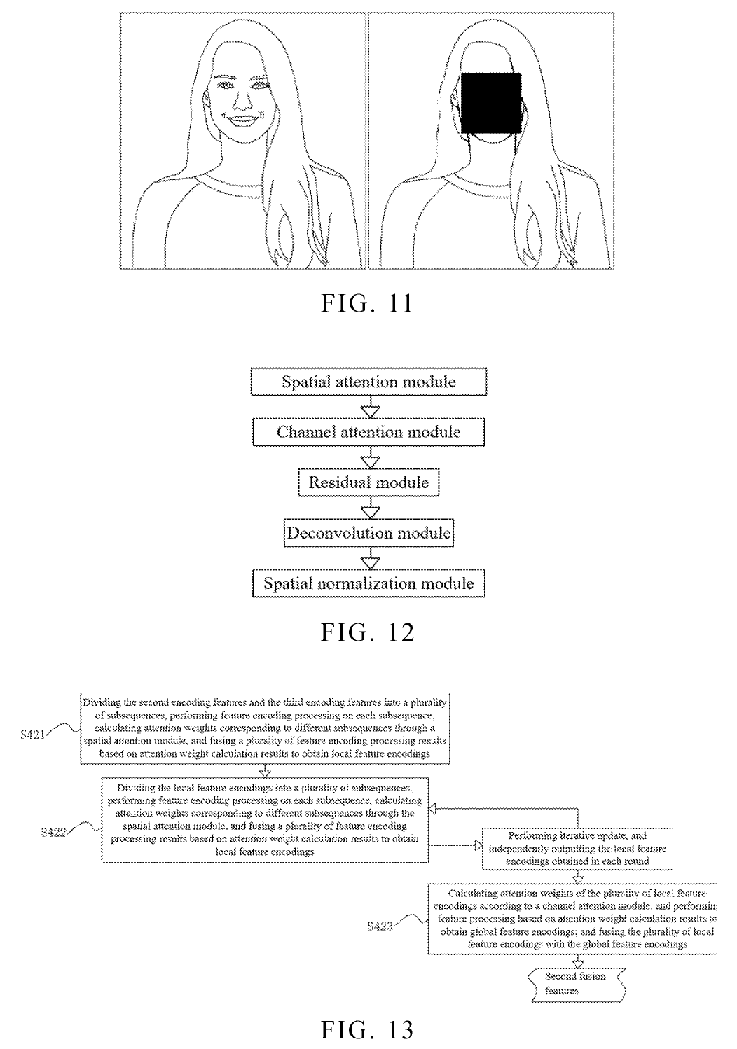

FIG. 12 is a schematic diagram of the expression generation model in the method for generating driven digital human expression of the present application.

FIG. 13 is a flow chart of a second processing in the method for generating driven digital human expression of the present application.

As can be seen from FIG. 12 and FIG. 13, further, in some embodiments, the second processing includes:

S421, dividing the second encoding features and the third encoding features into a plurality of subsequences, performing feature encoding processing on each subsequence, calculating attention weights corresponding to different subsequences through a spatial attention module, and fusing a plurality of feature encoding processing results based on attention weight calculation results to obtain local feature encodings; where the spatial attention module is preset in the expression generation model. Specifically, in the present embodiment, through sequence division, attention weight calculation, and local feature encoding according to the attention weights performed in sequence on the second encoding features and the third encoding features, a spatial attention mechanism is introduced in the calculation process of local features. The spatial attention mechanism focuses on important points of each spatial position in the feature map, so it has a better presentation result in calculating the attention of local regions.

Dividing the second encoding features and the third encoding features into a plurality of subsequences further includes the following operations:

performing sequence division on the second encoding features and the third encoding features respectively, and finally performing normalization processing on the results of the two; or, performing normalization operations on the second encoding features and the third encoding features in the early stage, and then performing sequence division on the fused features.

It should be noted that the division operations on the second encoding features and the third encoding features may vary according to different application scenarios, but the preferred solution is to perform sequence division on the second encoding features and the third encoding features respectively, and finally perform normalization processing on the results of the two.

The second processing further includes:

S422, dividing the local feature encodings into a plurality of subsequences, performing feature encoding processing on each subsequence, calculating attention weights corresponding to different subsequences through the spatial attention module, and fusing a plurality of feature encoding processing results based on attention weight calculation results to obtain local feature encodings. Specifically, in the present embodiment, similar to the above step S421, local feature analysis is performed on the feature encodings, but the difference from step S421 is that after step S422 is completed, it is necessary to perform iterative update on the obtained feature encodings, to perform cyclic local feature analysis on the updated feature encodings, and to output the obtained local feature encodings independently after each round of local feature analysis.

The second processing further includes:

S423, calculating attention weights of the plurality of local feature encodings according to a channel attention module, and performing feature processing based on attention weight calculation results to obtain global feature encodings; and fusing the plurality of local feature encodings with the global feature encodings to obtain the second fusion features; where the channel attention module is preset in the expression generation model. Specifically, in the present embodiment, after several rounds of local feature analysis, several local feature encodings can be obtained. In step S423, further feature analysis needs to be performed on these local feature encodings. The core purpose of step S423 is to introduce a channel attention mechanism in the feature analysis process. The channel attention mechanism focuses on calculating the importance of different feature channels relative to the global, so it has better presentation in terms of the effect of calculating global features.

Through steps S421 to S423, local analysis and global analysis of features are realized, so that the understanding of features by the expression generation model can be enhanced.

The above-mentioned target 3D face reconstruction model helps to improve the accuracy and detail richness of reconstructed facial expression images; at the same time, the feature fusion unit also has other advantages:

faster convergence speed: the introduction of residual structures makes convergence easier; and

stronger generalization ability: it has multi-scale feature fusion, integrating local and global information, which helps to enhance the generalization ability of the model and generate more natural and reasonable images.

The training process adopts pre-training technology, and 20 rounds of training are conducted on a total of one million pieces of big data, including collected open-source expression video data and rich expression video data collected from the Internet, ensuring the accuracy of facial coefficient extraction and the generalization of the model; and

through the feature fusion unit and the second convolution encoding unit, the 3D face reconstruction model is improved. On the collected big data of diverse expression videos, regression training is performed on multiple tasks of human faces and facial coefficients of human faces, enabling the model to accurately extract facial coefficients of expression faces.

Correspondingly, the specific structure, training, and functions of the target expression generation model are as follows:

During the training process of the target expression generation model, the driving person video is input to obtain the corresponding facial coefficients first based on the aforementioned target 3D face reconstruction model, then the obtained facial coefficients and the driven digital human image are used as input, the corresponding expression image of the driven digital human is output, and the expression images are combined to form the final expression video of the driven digital human; and the facial coefficients are input to the convolution module for encoding to obtain expression features; similarly, the driven digital human image is input to the convolution module for encoding to obtain facial features; and the above expression features and facial features are input to the adaptive attention normalization module for feature fusion.

The adaptive attention normalization module is an upgraded version of the attention normalization module. Conventional adaptive normalization does not consider local feature statistics, which easily outputs unnatural expression faces and local distortions. The adaptive attention normalization module dynamically adjusts the correlation between expression features and facial features by introducing an attention mechanism, and performs adaptive weighting and feature fusion, thereby reducing information loss.

Specifically, in the process of convolution encoding of facial coefficients and the driven digital human image, both shallow features (i.e., the output of the convolution layer at the front position in the hierarchical relationship) and deep features (i.e., the output of the convolution layer at the relatively rear position in the hierarchical relationship) are input to the adaptive attention normalization module as corresponding expression features and facial features, so that the adaptive attention normalization module can comprehensively consider the deep and shallow features of the corresponding image, and then learn the spatial information of expressions and faces, especially for local details, which can be better captured.

On this basis, the adaptive attention normalization module first calculates an attention weight distribution map according to the above expression features and facial features containing spatial information. This weight distribution map is used to characterize which regions in the facial features are most critical for realizing expression transformation (such as eyes, mouth, etc., these parts are usually most sensitive to expression changes, and different expressions will further lead to different attention weights among some details in the above parts).

On this basis, the similarity between expression features and facial features can be further measured (approaches such as cosine similarity), and the aforementioned attention weights are further adjusted based on the similarity between expression features and facial features.

After completing the above adjustments, the calculated attention weights are used to perform weighting on the facial features to enhance the features related to the expression features. On this basis, the weighted facial features are merged with the expression features to generate a new feature representation, which contains both the identity information of the facial features and the changes of the target expression.

The advantages of the above adaptive attention normalization module further include:

Improving model capability: Due to the introduction of the attention mechanism, the adaptive attention normalization module can more finely control feature fusion and generation results, thereby improving the quality and details of the generated images and making the output more coherent and natural.

Improving robustness: The adaptive attention normalization module adaptively adjusts the weights of feature fusion through the attention mechanism, better focuses on important features, is more robust to input disturbances, and enhances the generalization and robustness of the model.

The above fusion features are input to the residual network module and the deconvolution module. The residual network module learns residuals through skip residual connections, which can effectively avoid gradient disappearance, capture deep features, speed up model convergence and improve the generalization ability of the model; and deconvolution can ensure that more effective information is retained during up-sampling, better restore high-resolution image details, and improve image generation quality; and

the output features of the above deconvolution are input to the spatial normalization module. The spatial normalization module mainly includes five normalized residual layers. The parameter adjustment of each normalized residual layer is learned using the spatial normalization module; the normalized residual layer is similar to batch normalization, and normalization is performed in a channel manner during activation; the main function of this module is to further extract deep features, and at the same time, the spatial normalization module adaptively adjusts normalization parameters, applies different features to different positions of the expression face, can better retain image details, avoid blurring and distortion problems, make the generated expression face more accurate and natural, and can better reconstruct facial texture details.

Through the above self-developed expression generation model, image reconstruction of the driven digital human face with the corresponding driving person expression can be realized, and accurate facial expression migration and facial texture reconstruction can be realized.

For the training of the above expression generation model, the L1 loss-function is adopted. The L1 deviation between the real expression image and the predicted expression image is calculated to make the predicted expression more accurate; at the same time, to ensure that the generated facial expression changes are more natural and the facial texture is more accurate, dynamic facial region mask enhancement and corresponding regional L1 deviation calculation are added, and its weight is set to 10. The above correspond to two face discriminators, which perform L1 reconstruction loss and discriminant loss of expression images respectively, making the face, corresponding expression and facial texture more accurate and natural.

The above training also adopts pre-training technology. Facial coefficients are extracted based on three million expression video big data and pre-trained for 20 rounds. For each user, five minutes of diverse expression videos can be provided for fine-tuning, with only five training rounds, and the rest remain the same, which can reduce training costs and achieve personal customization effects.

In the actual application of the above method for generating a driven digital human, the driven digital human video is decoded into a sequence of image frames, and the driving person video stream is obtained through video capture equipment. During training, the driving person and the driven digital human are the same person, mainly to facilitate loss calculation for regression expression images. During testing, the driving person and the driven digital human can be different persons or the same person; the improved 3D face reconstruction model is used to extract the facial coefficients of the driving video, which are input into the trained expression generation model together with the driven digital human image, and the driven digital human image with the corresponding expression can be output. Continuous expression images are encoded into a video for display on terminal equipment.

Exemplarily, in this exemplary embodiment, a virtual psychotherapist is taken as an example for illustration. The beautified driven digital human image video and the driving person video are uploaded to train the expression generation model in the cloud. After training, by extracting the driving person facial coefficients in real-time and inputting them into the model together with the driven digital human image video frames, the generation of the corresponding expression of the driven image is realized. At the same time, combined with audio-driven mouth shape related technology, the effect is displayed through streaming, which can provide patients with rich emotional feedback and enhance interaction and communication.

It should be noted that the solution provided in the present embodiment can be applied as an independent expression migration function to live streaming with goods, virtual chat, virtual diagnosis and treatment, or short video creation, and can also be integrated into hardware devices as an extended function.

The present embodiment has the following advantages:

By improving the 3D face reconstruction model, the facial coefficients of diverse expression faces can be extracted more accurately.

By introducing an attention mechanism to dynamically adjust the correlation between expression features and facial features, adaptive weighting and feature fusion are performed, focusing on important features to avoid local distortion.

By extracting deep features and combining spatially adaptive normalization, different features are applied to different positions of the expression face, which can better retain image details, making the generated expression face and facial texture details more accurate and natural.

What is claimed is:

1. A method for generating driven digital human expression, comprising:
acquiring a driving video and a driven video, wherein the driving video is an expression provider for the driven video;
inputting the driving video into a target 3D face reconstruction model to obtain target facial coefficient features, wherein the target 3D face reconstruction model performs feature extraction on the driving video based on a skip connection approach;
inputting the target facial coefficient features and the driven video into a target expression generation model, wherein the target expression generation model is configured to perform global feature analysis and local feature analysis according to the target facial coefficient features and the driven video, so as to obtain a driven image with a target expression; and
performing video encoding based on the driven image to obtain a target video, wherein the target video is a video combining face information of the driven video with the target expression of the driving video;
wherein the target 3D face reconstruction model comprises a convolution encoding unit, an image masking unit, a 3D face mesh reconstruction unit, a feature fusion unit, and a second convolution encoding unit;
wherein the feature fusion unit comprises an encoding layer and a decoding layer, wherein the encoding layer comprises a first encoding layer, a second encoding layer, and a third encoding layer connected in sequence, the decoding layer comprises a first decoding layer, a second decoding layer, and a third decoding layer connected in sequence, wherein the third encoding layer is connected with the first decoding layer; and a skip connection is presented between the encoding layer and the decoding layer;
wherein the first encoding layer, the second encoding layer, and the third encoding layer are all configured to perform down-sampling on features input from a previous layer; and the first decoding layer, the second decoding layer, and the third decoding layer are all configured to perform up-sampling on features input from the previous layer;
wherein the convolution encoding unit and the 3D face mesh reconstruction unit are configured to perform reconstruction processing on the driving video; the image masking unit is configured to perform masking processing on the driving video; the feature fusion unit and the second convolution encoding unit are configured to perform feature fusion processing, based on residuals and skip connections, on the features processed by the image masking unit and the 3D face mesh reconstruction unit.

2. The method for generating driven digital human expression according to claim 1, wherein a training process of the target 3D face reconstruction model comprises:
acquiring an expression video, and performing first preprocessing on the expression video to obtain a target expression video; and
performing model training and convergence according to the target expression video and a 3D face reconstruction model to obtain the target 3D face reconstruction model.

3. The method for generating driven digital human expression according to claim 2, wherein a step of performing model training according to the target expression video and the 3D face reconstruction model comprises:
selecting several frames of training expression images from the target expression video;
performing first processing according to the training expression images to obtain facial coefficient features; and
repeating the training of the 3D face reconstruction model, and performing convergence on the facial coefficient features by using a first loss-function until the 3D face reconstruction model meets a first requirement, so as to obtain the target 3D face reconstruction model.

4. The method for generating driven digital human expression according to claim 3, wherein a procedure of performing first processing according to the training expression images comprises:
performing reconstruction processing and masking processing on the training expression images respectively to obtain first reconstruction features and first masked images;
performing skip feature fusion processing according to the first reconstruction features and the first masked images to obtain first fusion features; and
performing encoding processing on the first fusion features to obtain the facial coefficient features.

5. The method for generating driven digital human expression according to claim 4, wherein a procedure of performing reconstruction processing on the training expression images comprises:
performing encoding processing on the training expression images to obtain first encoding features; and
performing 3D face mesh reconstruction on the first encoding features to obtain the first reconstruction features.

6. The method for generating driven digital human expression according to claim 4, wherein a procedure of performing convergence on the facial coefficient features by using the first loss-function comprises:
calculating a first deviation between the facial coefficient features and the training expression images by using an L1 loss-function;
calculating a second deviation between the facial coefficient features and the training expression images by using a cycle loss-function; and
stopping the training of the 3D face reconstruction model when both the first deviation and the second deviation meet the first requirement, so as to obtain the target 3D face reconstruction model.

7. The method for generating driven digital human expression according to claim 3, wherein a training process of the target expression generation model comprises:
acquiring a training driving video, and performing second preprocessing on the training driving video to obtain a target training driving video; and
performing model training and convergence according to the target training driving video, the facial coefficient features, and an expression generation model, so as to obtain the target expression generation model.

8. The method for generating driven digital human expression according to claim 7, wherein a procedure of performing model training and convergence according to the target training driving video, the facial coefficient features, and the expression generation model comprises:
performing convolution encoding on the target training driving video and the facial coefficient features respectively to obtain second encoding features and third encoding features;
performing feature fusion on the second encoding features and the third encoding features by using a second processing to obtain second fusion features, wherein the second processing comprises adaptive normalization processing with an attention mechanism;
performing residual calculation on the second fusion features to obtain first residual features;
performing deconvolution processing on the first residual features to obtain first deconvolution features;
performing third processing on the first deconvolution features to obtain a training driven image, wherein the third processing comprises extracting deep features in the first deconvolution features by using spatial normalization processing, and adjusting normalization parameters of the spatial normalization processing uniformly and adaptively;
performing video encoding according to the training driven image to obtain a training target video; and
performing convergence on the training target video by using an L1 loss-function until the expression generation model meets a second requirement, so as to obtain the target expression generation model.

9. The method for generating driven digital human expression according to claim 8, wherein the second processing comprises:
dividing the second encoding features and the third encoding features into a plurality of subsequences, performing feature encoding processing on each of the subsequences, calculating attention weights corresponding to different subsequences through a spatial attention module, and fusing a plurality of feature encoding processing results based on attention weight calculation results to obtain local feature encodings, wherein the spatial attention module is preset in the expression generation model;
dividing the local feature encodings into a plurality of subsequences, performing feature encoding processing on each of the subsequences, calculating attention weights corresponding to different subsequences through the spatial attention module, and fusing a plurality of feature encoding processing results based on attention weight calculation results to obtain local feature encodings;
performing iterative update, and independently outputting the local feature encodings obtained in each round to obtain a plurality of local feature encodings; and
calculating attention weights of the plurality of local feature encodings according to a channel attention module, and performing feature processing based on attention weight calculation results to obtain global feature encodings; and fusing the plurality of local feature encodings with the global feature encodings to obtain the second fusion features; wherein the channel attention module is preset in the expression generation model.

10. The method for generating driven digital human expression according to claim 8, wherein a sub-procedure of performing convergence on the training target video by using the L1 loss-function comprises:
calculating a third deviation between the training target video and the target expression video by using the L1 loss-function; and
stopping the training of the expression generation model when the third deviation meets the second requirement, so as to obtain the target expression generation model.
